(19) United States
(12) Patent Application Publication
(10) Pub. No.: US 2006/0232602 A1
(43) Pub. Date: Oct. 19, 2006

(54) Font generation system

(75) Inventors: Brinton King, Hampshire (GB); Neil Cormican, London (GB)

Correspondence Address: WELSH & KATZ, LTD, 120 S RIVERSIDE PLAZA, 22ND FLOOR, CHICAGO, IL, 60606, US

(73) Assignee: NDS Limited, West Drayton (GB)

(21) Appl. No.: 11/392,172

(22) Filed: Mar. 29, 2006

Related U.S. Application Data
(63) Continuation of application No. PCT/GB05/02459, filed on Jun. 23, 2005.
(60) Provisional application No. 60/643,032, filed on Jan. 11, 2005.

(30) Foreign Application Priority Data
Jan. 10, 2005 (GB) 0500410.6

(51) Int. Cl. G09G 5/00; G06K 9/40

(52) U.S. Cl. 345/611; 382/269

(57) ABSTRACT

A method for displaying a simulated anti-alias font on a display device, the method comprising providing a first font element, the first font element being semi-transparent, providing a second font element, and rendering the first font element and the second font element on top of each other on the display device, thereby displaying a simulated anti-alias font including at least part of the first font element and at least part of the second font element. Related apparatus and methods are also described.

### RELATED APPLICATION INFORMATION

The present application claims priority from UK Patent Application S/N 0500410.6 of NDS Limited, filed on 10 Jan. 2005 and U.S. Provisional Patent Application Ser. No. 60/643,032 of King, et al. filed on 11 Jan. 2005, the disclosures of which are hereby incorporated herein by reference.

### FIELD OF THE INVENTION

The present invention relates to techniques for font generation and display in computerized systems.

### BACKGROUND OF THE INVENTION

It is well-known in the art that font rendering of 1-bit fonts allows for only two colors on a bitmap font. Persons skilled in the art will appreciate that one of the two colors needs to be transparent so that any underlying content is still visible; the other color defines the main font color. A significant problem with using a 1-bit font in this way is well-known in the art: there is often a sharp contrast between the font color and the background causing flickering and generally poor quality font rendering.

Reference is now made to FIG. 1, which is a simplified pictorial illustration of a typical 1-bit font 10. The 1-bit font 10 is shown displayed over four different background colors (which may be taken to represent, for example, red 12, blue 14, green 16, and white 18 ), along with an enlargement of the letter “e”.

Reference is now made to FIG. 2, which is a simplified pictorial illustration of a 2-bit anti-alias font 20. The standard solution to the problem discussed with reference to FIG. 1, which solution is well-known in the art, is to use a 2-bit anti-alias font. In a 2-bit anti-alias font, the font and background colors are analyzed. Typically, the 2-bit font 20 has four colors: opaque 19, 100 percent transparent 21, and two degrees of partial transparency (such as, for example, 33 percent transparent 23 and 67 percent transparent 25). An example of such a font is shown in FIG. 2 as the 2-bit anti-alias font 20. Persons skilled in the art will appreciate that, when a 2-bit anti-alias font character is placed on a background, the partially transparent fonts will display a new color which is (in the example of FIG. 2 a 67 percent transparent font) 33 percent of the font color and 67 percent of the background color.

Anti-aliasing, is explained, for example, at the following site on the World Wide Web:

www.isocalc.com/tutorials/antialias.htm

The following references are also believed to represent the state of the art:

U.S. Pat. No. 5,390,289 to Beitel, et al.; and

Published U.S. Patent Application No. 2002/0167530 of Hiratsuka, et al.

The disclosures of all references mentioned above and throughout the present specification, as well as the disclosures of all references mentioned in those references, are hereby incorporated herein by reference.

### SUMMARY OF THE INVENTION

The present invention, in preferred embodiments thereof, seeks to provide improved techniques for font generation and display in computerized systems; the techniques provided by the present invention are particularly, but not exclusively, useful in systems which have the ability to display only 1-bit fonts, and systems in which display of more-than-1-bit fonts is difficult.

Production of a true anti-alias font, as is known in the prior art, requires increased processing resources and time. In a context in which hardware resources are limited, processing will be slowed significantly because of the need to analyze both font and background colors, and then to re-calculate each pixel color to create the anti-alias font on the fly.

The present invention, in preferred embodiments thereof, overcomes the limitations of the prior art by providing more than one 1-bit font element, typically but not necessarily two 1-bit font elements, and rendering the fonts over each other to simulate anti-aliasing. Therefore, it is not necessary to perform conventional anti-alias processing, in which a 2 bit (or more bits) font is rendered, in order to display the simulated anti-alias font. In some contexts in which hardware resources are limited such a font may be quite suitable. For example, in a case of a typical digital television system having a set-top-box with limiting processing power, the inventors of the present invention believe that such a simulated anti-aliasing font, when displayed on a typical television display, adequately simulates an anti-alias font.

There is thus provided in accordance with a preferred embodiment of the present invention a method for displaying a simulated anti-alias font on a display device, the method including providing a first font element, the first font element being semi-transparent, providing a second font element, and rendering the first font element and the second font element on top of each other on the display device, thereby displaying a simulated anti-alias font including at least part of the first font element and at least part of the second font element.

Further in accordance with a preferred embodiment of the present invention the second font element is at least partially slimmer than the first font element.

Still further in accordance with a preferred embodiment of the present invention the first font element has a transparency level between 20 percent and 80 percent.

Additionally in accordance with a preferred embodiment of the present invention the first font element and the second font element are one-bit font elements.

Moreover in accordance with a preferred embodiment of the present invention, the method includes providing a third font element, the third font element being semi-transparent, the third font element having a different transparency level than a transparency level of the first font element, wherein the rendering is performed by rendering the first font element, the second font element and the third font element on top of each other, thereby displaying the simulated anti-alias font, the simulated anti-alias font also including at least part of the third font element.

Further in accordance with a preferred embodiment of the present invention the first font element has a transparency level between 20 percent and 60 percent and the third font element has a transparency level between 40 percent and 80 percent.

Still further in accordance with a preferred embodiment of the present invention the third font element is a one-bit font element.

Additionally in accordance with a preferred embodiment of the present invention the simulated anti-alias font is displayed using only one-bit font elements.

There is also provided in accordance with another preferred embodiment of the present invention a system for displaying a simulated anti-alias font on a display device, the system including a font store to provide a plurality of font elements including a first font element and a second font element, the first font element being semi-transparent, and a font rendering module to render the first font element and the second font element on top of each other on the display device, thereby displaying a simulated anti-alias font including at least part of the first font element and at least part of the second font element.

Additionally in accordance with a preferred embodiment of the present invention the second font element is at least partially slimmer than the first font element.

Moreover in accordance with a preferred embodiment of the present invention the first font has a transparency level between 20 percent and 80 percent.

Further in accordance with a preferred embodiment of the present invention the first font element and the second font element are one-bit font elements.

Still further in accordance with a preferred embodiment of the present invention the font elements include a third font element, the third font element being semi-transparent, the third font element having a different transparency level than a transparency level of the first font element, the font rendering module being adapted to render the first font element, the second font element and the third font element on top of each other, thereby displaying the simulated anti-alias font also including at least part of the third font element.

Additionally in accordance with a preferred embodiment of the present invention the first font element has a transparency level between 20 percent and 60 percent and the third font element has a transparency level between 40 percent and 80 percent.

Moreover in accordance with a preferred embodiment of the present invention the third font element is a one-bit font element.

Further in accordance with a preferred embodiment of the present invention the simulated anti-alias font is displayed using only one-bit font elements.

### BRIEF DESCRIPTION OF THE DRAWINGS

The present invention will be understood and appreciated more fully from the following detailed description, taken in conjunction with the drawings in which:

FIG. 1 is a simplified pictorial illustration of a 1-bit font;

FIG. 2 is a simplified pictorial illustration of a 2-bit anti-alias font;

FIG. 3 is simplified pictorial illustration of a partially transparent 1-bit font element in accordance with a preferred embodiment of the present invention;

FIG. 4 is a simplified pictorial illustration of a slimmed-down 1-bit font element, useable in conjunction with the font element of FIG. 3;

FIG. 5 is a simplified pictorial illustration of a font produced by rendering the font element of FIG. 4 over the font element of FIG. 3, in accordance with a preferred embodiment of the present invention;

FIG. 6 is a simplified pictorial illustration of three 1-bit font elements being rendered on top of each other in accordance with an alternative preferred embodiment of the present invention;

FIG. 7 is a simplified block diagram of a font rendering system constructed and operative in accordance with a preferred embodiment of the present invention; and

FIG. 8 is a simplified flowchart showing a preferred method of operation of the font rendering system of FIG. 7.

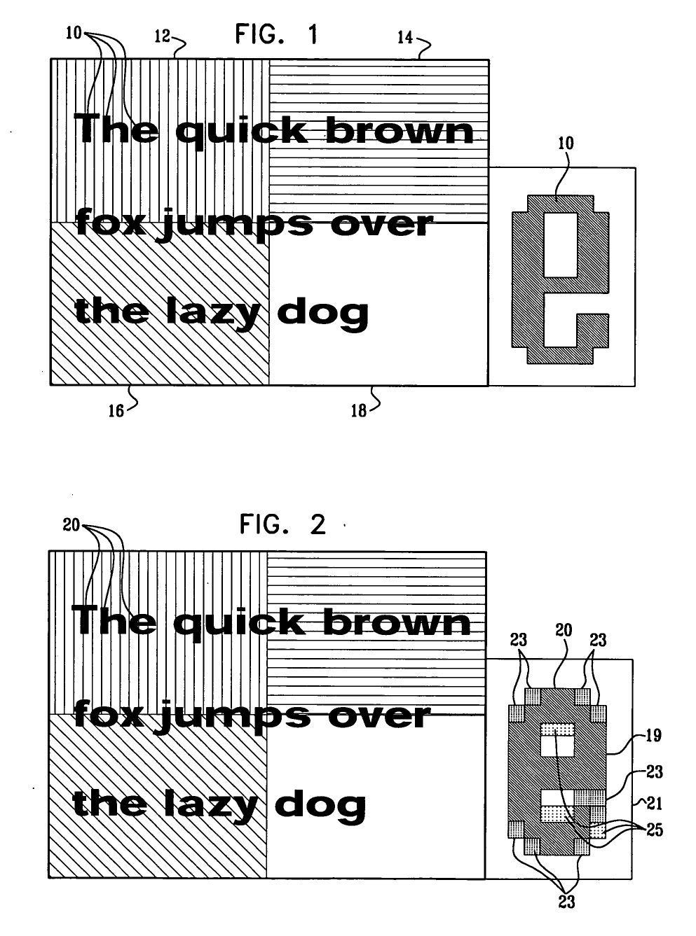

### DETAILED DESCRIPTION OF A PREFERRED EMBODIMENT

By way of introduction, in preferred embodiments of the present invention, two 1-bit font elements are provided. At least one of the font elements is preferably semi-transparent. The font elements are preferably rendered over the top of each other on a display device thereby displaying a simulated anti-alias font including at least part of each font element, the semi-transparency typically being used to simulate the anti-aliasing. Therefore, it is not necessary to perform conventional anti-alias processing, in which a 2 bit (or more bits) font is rendered, in order to display the simulated anti-alias font; the simulated anti-alias font is displayed using only one-bit font elements. The term “only one-bit” as used in the specification and claims is defined to exclude two (or more bits) fonts or font elements. It will be appreciated that more than two font elements, and font rendering more than twice, may be used for additional color depth.

The term “font element” in all of its grammatical forms as used in the claims and the specification of the present application is defined to include the following: an element which when rendered on top of one or more font elements forms a font character, an element which forms a font character by itself, and/or an element which when rendered on top of a font character enhances the font character.

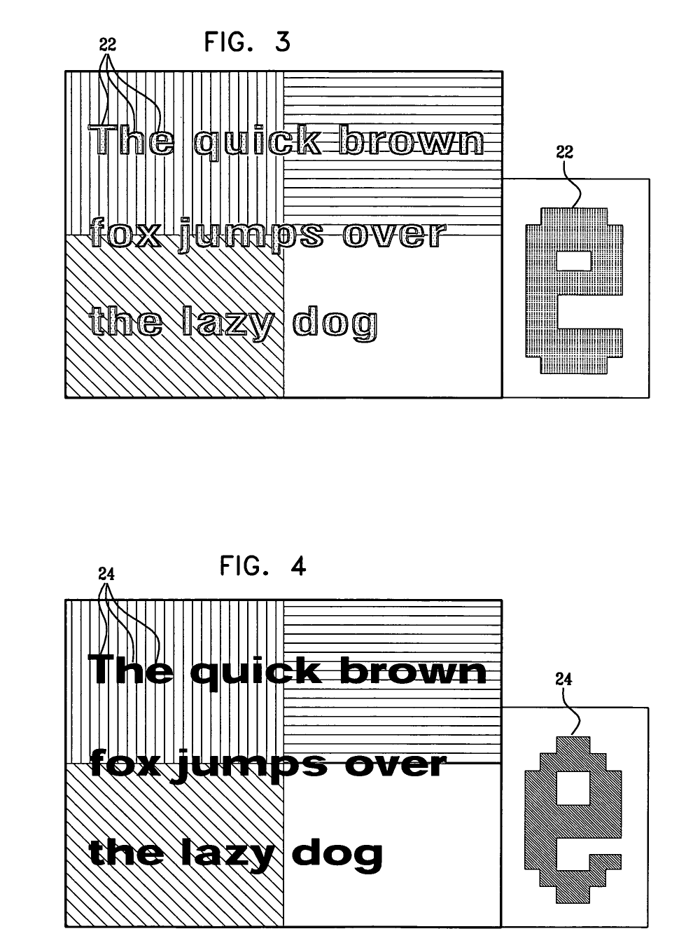

Reference is now made to FIG. 3, which is simplified pictorial illustration of a partially transparent 1-bit font element 22 in accordance with a preferred embodiment of the present invention. For example, and without limiting the generality of the foregoing, the partially transparent 1-bit font element 22 is typically between 20 percent and 80 percent, preferably about 50 percent, transparent, but another degree of transparency may be used depending on the amount of preferred anti-aliasing.

Reference is now made to FIG. 4, which is a simplified pictorial illustration of a slimmed-down 1-bit font element 24, useable in conjunction with the partially transparent 1-bit font element 22 of FIG. 3. The slimmed-down 1-bit font element 24 is preferably in full color (fully opaque). The slimmed-down 1-bit font element 24 is “slimmer”, at least in some places, than the partially transparent 1-bit font element 22, such that, if the slimmed-down 1-bit font element 24 is rendered on top of the partially transparent 1-bit font element 22, the partially transparent 1-bit font element 22 can still be seen “around” the slimmed-down 1-bit font element 24, at least in some places.

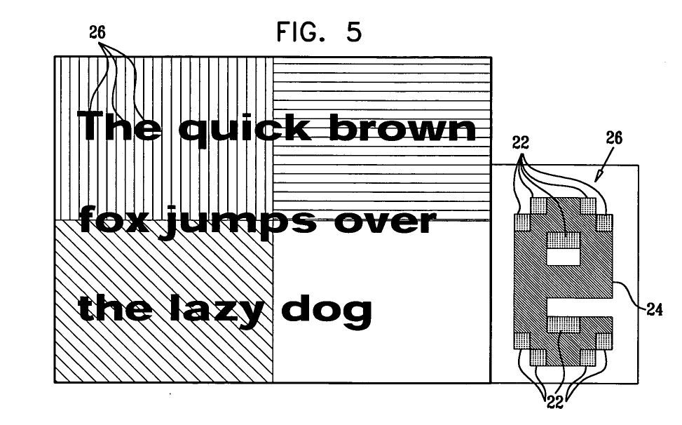

Reference is now made to FIG. 5, which is a simplified pictorial illustration of a font 26 produced by rendering the slimmed-down 1-bit font element 24 of FIG. 4 over the partially transparent 1-bit font element 22 of FIG. 3, in accordance with a preferred embodiment of the present invention. The rendering of the slimmed-down 1-bit font element 24 on top of the partially transparent 1-bit font element 22 generally produces the simulated anti-alias font 26. Alternatively and equivalently, the order may be reversed, with the partially transparent 1-bit font element 22 being rendered on top of the slimmed-down 1-bit font element 24.

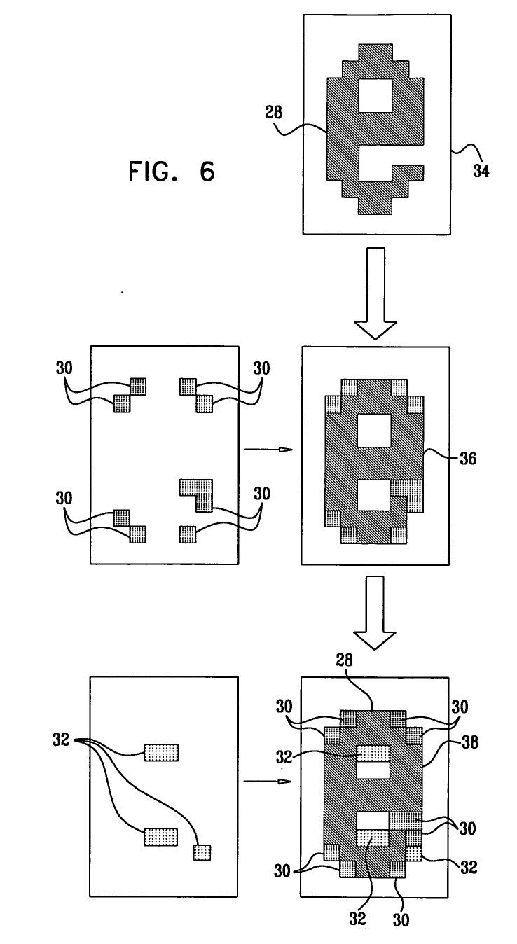

Reference is now made to FIG. 6, which is a simplified pictorial illustration of three 1-bit font elements 28, 30, 32 being rendered on top of each other in accordance with an alternative preferred embodiment of the present invention. Three font elements 28, 30, 32 are provided. The font element 28 is typically a full color (fully opaque) font element. Additionally, the font element 28 typically forms a complete 1-bit font character, the letter “e” being shown by way of example only. On the other hand, the font elements 30, 32 are preferably semi-transparent font elements. The font element 30 and the font element 32 preferably have different transparency levels. The font element 30 typically has a transparency level between 20 percent and 60 percent, preferably about 40 percent. The font element 32 typically has a transparency level between 40 percent and 80 percent, preferably 60 percent. Additionally, the font elements 30, 32, as shown in the example of FIG. 6, are not complete font characters. The font elements 30, 32 are used in conjunction with one or more font elements, for example the font element 28, in order to form a complete and/or enhanced font character. However, it will be appreciated by those ordinarily skilled in the art that the font elements 30, 32 can alternatively be complete font characters.

The font element 28 is typically displayed on a display device 34. The font element 30 is preferably rendered on top of the font element 28 on the display device 34, thereby displaying a simulated two-tone anti-alias font 36. The font element 32 is then typically rendered on top of the two-tone anti-alias font 36, thereby displaying a simulated three-tone anti-alias font 38 including at least part of each of the font elements 28, 30, 32. It will be appreciated by those ordinarily skilled in the art that the font elements 28, 30, 32 can be rendered on top of each other in any order.

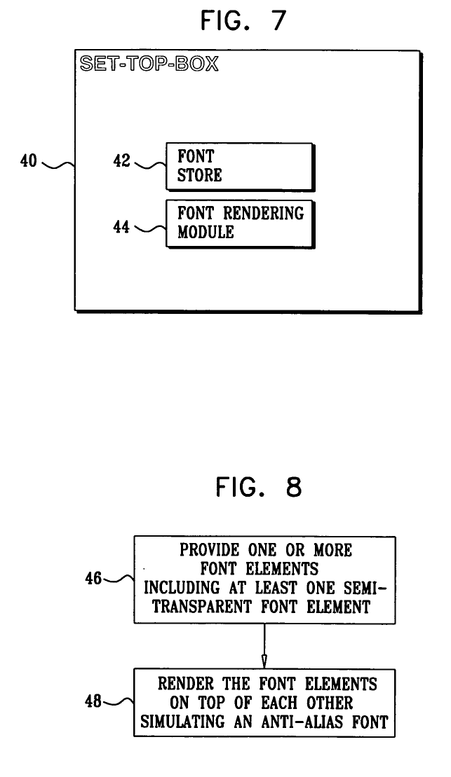

Reference is now made to FIGS. 7 and 8. FIG. 7 is a simplified block diagram of a font rendering system 40 constructed and operative in accordance with a preferred embodiment of the present invention. FIG. 8 is a simplified flowchart showing a preferred method of operation of the font rendering system 40 of FIG. 7. The font rendering system 40 is for displaying a simulated anti-alias font on a display device (not shown). The display device is typically any suitable display device for displaying non-printed images for example, but not limited to, a cathode-ray screen, a projector device in conjunction with a projector screen, a plasma screen, or an LCD screen. In accordance with a most preferred embodiment of the present invention, the font rendering system 40 is implemented in a set-top box (STB) otherwise known as an integrated receiver decoder (IRD). However, it will be appreciated by those ordinarily skilled in the art that font rendering system 40 can be implemented in any suitable device for rendering fonts on to a suitable display.

The font rendering system 40 preferably includes a font store 42 to provide a plurality of font elements, at least one of the font elements being a semi-transparent font element (block 46) for example, but not limited to the font elements 22, 24 of FIGS. 3-5 and the font elements 28, 30, 32 of FIG. 6. The font rendering system 40 also preferably includes a font rendering module 44 to typically render the font elements on top of each other on the display device, thereby generally displaying a simulated anti-alias font including at least part of each of the rendered font elements (block 48). The font rendering system 40 does not generally perform conventional anti-alias processing, in which a 2 bit (or more bits) font is rendered, in order to display the simulated anti-alias font; the simulated anti-alias font is displayed using only one-bit font elements.

A particularly detailed preferred method for producing font elements, such as the font elements 22, 24 of FIGS. 3 and 4 and font elements 28, 30, 32 of FIG. 6, is now described, it being appreciated that the method is provided by way of example only and is not meant to be limiting.

Industry standard software for producing and editing bitmap fonts is preferably used; a preferred example of such software is BitFonter, commercially available from FontLab Ltd. of 136 East 8th St, PMB 230, Port Angeles, Wash. 98362 USA. In the following description, features of BitFonter are described; persons skilled in the art will appreciate that similar features of another appropriate software product for producing and editing bitmap fonts may be used, mutatis mutandis.

A 2-bit font is generally imported into the software at the desired size, at grayscale with typically four levels of gray.

The full font character set is editable in the viewer. The font artist typically goes through each of the glyphs to edit them, generally using a window which displays the characters in a large format, with each square in a grid representing the individual pixels that make up the character (glyph).

The 2-bit font is made of 4 colors: white, which is the fully transparent color; two levels of gray which produce the anti-aliasing of the 2-bit font; and black, which is the fully opaque color.

The designer needs to reduce the character from 4 colors to 3: white, one gray and black; however, it is not as simple as reducing both the grays to a single gray; certain gray pixels will become black or white. The resulting font looks like the font which will be finally rendered on the screen (such as, for example, the font 26 of FIG. 5). It will be appreciated by those ordinarily skilled in the art that the step of reducing the character from 4 colors to 3 does not generally need to be performed in the formation of the font elements 28, 30, 32 of FIG. 6 as the font element 30 includes one level of gray and the font element 32 includes another level of gray.

The next step is to separate the font into separate font elements of two colors only, i.e. white and one other color, thereby producing two or three new 1-bit font elements (such as, for example, the font elements 22, 24 of FIGS. 3 and 4 and the font elements 28, 30, 32 of FIG. 6), one for the black layer and one for each gray layer (if two levels of gray are used), or a single gray font element (if one level of gray is used). The characters are typically cut and pasted into the new font elements. It is important that the characters be exactly aligned with the baseline and the glyph metric lines in both font elements to ensure that the characters will be positioned correctly when rendered. The font elements are now exported in an appropriate format, such as .BDF format. The font elements may then be converted, using methods well-known in the art, into a programming language such as C; the font elements are now ready for use in a program, such as, for example, an Electronic Program Guide (EPG) program running on an STB.

It will be appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable sub-combination. It will also be appreciated by persons skilled in the art that the present invention is not limited by what has been particularly shown and described hereinabove. Rather the scope of the invention is defined only by the claims which follow.

1. A method for displaying a simulated anti-alias font on a display device, the method comprising:
providing a first font element, the first font element being semi-transparent;
providing a second font element; and
rendering the first font element and the second font element on top of each other on the display device, thereby displaying a simulated anti-alias font including at least part of the first font element and at least part of the second font element.

2. The method according to claim 1, wherein the second font element is at least partially slimmer than the first font element.

3. The method according to claim 1, wherein the first font element has a transparency level between 20 percent and 80 percent.

4. The method according to claim 1, wherein the first font element and the second font element are one-bit font elements.

5. The method according to claim 1, further comprising providing a third font element, the third font element being semi-transparent, the third font element having a different transparency level than a transparency level of the first font element,
wherein the rendering is performed by rendering the first font element, the second font element and the third font element on top of each other, thereby displaying the simulated anti-alias font, the simulated anti-alias font also including at least part of the third font element.

6. The method according to claim 5, wherein the first font element has a transparency level between 20 percent and 60 percent and the third font element has a transparency level between 40 percent and 80 percent.

7. The method according to claim 5, wherein the third font element is a one-bit font element.

8. The method according to claim 1, wherein the simulated anti-alias font is displayed using only one-bit font elements.

9. A system for displaying a simulated anti-alias font on a display device, the system comprising:
a font store to provide a plurality of font elements including a first font element and a second font element, the first font element being semi-transparent; and
a font rendering module to render the first font element and the second font element on top of each other on the display device, thereby displaying a simulated anti-alias font including at least part of the first font element and at least part of the second font element.

10. The system according to claim 9, wherein the second font element is at least partially slimmer than the first font element.

11. The system according to claim 9, wherein the first font has a transparency level between 20 percent and 80 percent.

12. The system according to claim 9, wherein the first font element and the second font element are one-bit font elements.

13. The system according to claim 9, wherein the font elements include a third font element, the third font element being semi-transparent, the third font element having a different transparency level than a transparency level of the first font element, the font rendering module being adapted to render the first font element, the second font element and the third font element on top of each other, thereby displaying the simulated anti-alias font also including at least part of the third font element.

14. The system according to claim 13, wherein the first font element has a transparency level between 20 percent and 60 percent and the third font element has a transparency level between 40 percent and 80 percent.

15. The system according to claim 13, wherein the third font element is a one-bit font element.

16. The system according to claim 9, wherein the simulated anti-alias font is displayed using only one-bit font elements.

17. A system for displaying a simulated anti-alias font on a display device, the system comprising:
means to provide a plurality of font elements including a first font element and a second font element, the first font element being semi-transparent; and
means to render the first font element and the second font element on top of each other on the display device, thereby displaying a simulated anti-alias font including at least part of the first font element and at least part of the second font element.
